(19) United States
(12) Patent Application Publication
(10) Pub. No.: US 2012/0029224 A1
(43) Pub. Date: Feb. 2, 2012

(54) PROCESS FOR THE PREPARATION OF HALOGENATED ARYL PHOSPHONATES

(75) Inventors: Royi Mazor, Beit-Kama (IL); Asher Shoshan, Beer-Sheva (IL); Michael Peled, Beer-Sheva (IL)

(73) Assignee: BROMINE COMPOUNDS LTD., Be'er-Sheva (IL)

(21) Appl. No.: 13/125,395

(22) PCT Filed: Oct. 22, 2009
(86) PCT No.: PCT/IL2009/000993

§ 371 Date: Sep. 15, 2011

Related U.S. Application Data
(60) Provisional application No. 61/107,690, filed on Oct. 23, 2008.
(60) Provisional application No. 61/146,329, filed on Jan. 22, 2009.

(51) Int. Cl. C07F 9/40

(52) U.S. Cl. 558/125; 558/162

(57) ABSTRACT

A process for preparing halogen-substituted aryl phosphonates represented by formula (I): wherein each Hal independently represents halogen; k is 1 or 2; n is an integer between 1 and 5, inclusive; m is an integer between 1 and 3, inclusive; and R is a straight or branched C1-C5 alkyl group which may be optionally substituted with one or more halogen atoms, which process comprises reacting under heating a compound represented by the following formula: wherein X is a leaving group, with trialkyl phosphite of the formula (RO)₃P, wherein the product of Formula I is produced and maintained in a liquid form and functions as an indigenous reaction liquid medium for suspending or dissolving the reactants, wherein the temperature of the reaction mixture is not less than the melting temperature of said compound of Formula I during at least a portion of the reaction time, and recovering the product of Formula I in a liquid form.

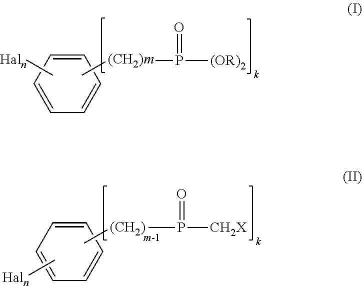

Diethyl pentabromobenzylphosphonate, a flame retardant which combines both bromine and phosphorous atoms, is represented by the following chemical formula:

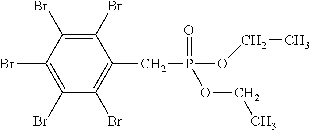

In its most general form, the synthetic procedure for preparing diethyl pentabromobenzylphosphonate involves the reaction of pentabromobenzyl bromide with triethyl phosphite. The reaction is accompanied by the evolution of ethyl bromide as a by-product.

More specifically, according to GB 2,228,939 the reaction between pentabromobenzyl bromide and triethyl phosphite is carried out in o-xylene as a solvent. The product, which is isolated from the reaction mixture by filtration, is reported to have a melting point of 123-124° C.

Liaw et al. [Journal of the Chinese Chemical Society, 31, p. 311-314 (1984)] describe similar preparations of diethyl pentabromobenzylphosphonate and structurally similar compounds, using benzene as a solvent. Upon completion of the reaction, the solvent is removed by evaporation under reduced pressure in order to recover the product.

WO 2006/124670 illustrates (see Example 2t) a reaction between pentabromobenzyl bromide and triethyl phosphite. It is noted that triethyl phosphite is used in a considerable molar excess over the stoichiometrically required amount, thus serving both as a reactant and as a solvent. Upon completing the reaction and cooling the reaction mixture, the diethyl pentabromobenzylphosphonate product precipitates from the triethyl phosphite liquid phase. The solid product is finally collected by filtration.

U.S. Pat. No. 4,036,809 discloses halogen-containing diphosphonates, that are obtained by reacting trialkyl phosphite with tetrabrominated xvlenes of the formula:

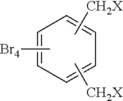

(wherein X is, inter alia, Br).

The present invention relates to a process for preparing diethyl pentabromobenzylphosphonate and structurally similar compounds, namely, the class of dialkyl halogen-substituted aryl phosphonates represented by formula (I):

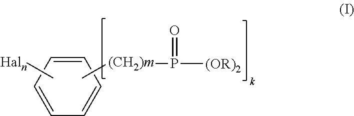

wherein each Hal independently represents halogen (preferably chlorine or bromine, especially bromine); k is 1 or 2; n is an integer between 1 and 5, and preferably between 3 and 5, inclusive; m is an integer between 1 and 3, inclusive; and R is a straight or branched C1-C5 alkyl group which may be optionally substituted with one or more halogen atoms (the R groups may be the same or different).

The starting materials used according to the present invention for preparing the product of Formula I are:

a compound having the formula II

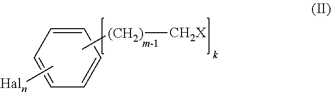

wherein Hal, n, m and k are as previously defined and X is a leaving group (preferably halide, namely, chloride or bromide); and
trialkyl phosphite of the formula (RO)₃P wherein R is as previously defined.

It has been found that the reaction product of Formula I, when in a liquid form, is capable of forming a stirrable reaction mixture together with the reactants used for making said product (the compound of formula II and the trialkyl phosphite). More specifically, the reaction mixture comprising the starting materials is heated, the product of formula I is progressively formed and maintained in a liquid state. In this way, the product (i.e., the compound of formula I in liquid form) itself provides an easily stirrable indigenous reaction liquid medium, in which the reaction may proceed and reach completion. By the term “indigenous reaction liquid medium” is meant a liquid component of the reaction mixture which is generated by the chemical reaction itself, and which also serves as the reaction solvent or diluent. Thus, according to the present invention, the reaction mixture does not require the presence of a non-indigenous diluent or solvent (by the term “non-indigenous diluent or solvent” is meant a liquid substance which is not involved in the reaction, e.g., an inert solvent as commonly applied). During the reaction, the starting materials are gradually consumed, whereby the reaction mixture is transformed into the product in its liquid form, while the haloalkane by-product is concurrently or subsequently removed from the reaction mixture (e.g., by distillation). The liquid product thus obtained may then be allowed to solidify. The fact that the reaction does not require the use of a non-indigenous solvent brings ecological and other benefits including lower toxicity, no effluent and reduced volatiles. Furthermore, the present invention has the benefit of yielding a pure alkyl halide by-product which can be useful in other manufacturing processes.

Accordingly, the process of the invention comprises reacting under heating a compound represented by Formula II:

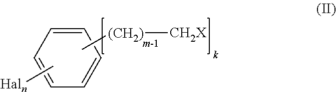

with trialkyl phosphite of the formula (RO)₃P wherein Hal, n, m, k, X in Formula II and R are as previously defined, wherein the product of Formula I is produced and maintained in a liquid form and functions as an indigenous reaction liquid medium for suspending and/or dissolving the reactants, wherein the temperature of the reaction mixture is not less than the melting temperature of said compound of Formula I during at least a portion of the reaction time, and recovering the product of Formula I in a liquid form.

More specifically, the process of the invention comprises reacting under heating a compound represented by Formula II and trialkyl phosphite, bringing the reaction to completion at a temperature which is not less than the melting temperature of the product of Formula I, wherein the reaction mixture is free of a non-indigenous diluent or solvent, removing the alkyl halide (RX) by-product from the reaction mixture, either concurrently with or subsequent to the reaction, obtaining a reaction mass comprising said compound of Formula I in a liquid state, wherein the compound of Formula I is recovered in a substantially pure liquid form at a temperature which is not less than the melting temperature of said compound of Formula I, and optionally solidifying said liquid of Formula I and collecting the product in a solid form.

Already prior to the completion of the reaction, the product of Formula I constitutes the predominant liquid component of the reaction mixture (namely, the amount of the compound of Formula I is greater than the amount of any other liquid component in the reaction mixture). The term “reaction mass” refers to the material present in the reaction vessel upon completion of the reaction. The reaction mass, which is formed and kept at a temperature which is at least equal to the melting point of the product of Formula I, is a liquid which preferably comprises not less than 90%, and more preferably not less than 97% and most preferably not less than 99% of said product (HPLC area percent). The product of Formula I is recovered, namely, obtained as substance, in a liquid state. Since the reaction does not require the use of a non-indigenous diluent or solvent, the reaction mass provides the product in a non-solute, directly isolatable form, such that neither solid/liquid phase separation (for collecting a solid product from its mother liquor), nor liquid/liquid separation (to remove a non-indigenous diluent or solvent), are required for collecting the product.

Most of the products represented by Formula I are solid at room temperature, such that cooling the liquid reaction mass results in a liquid-solid phase transition, directly affording a solid product. The solid product obtained by the process exhibits high degree of crystallinity and purity. Thus, subsequent recrystallization of the crude product in an organic solvent (e.g., ethyl acetate) is generally not necessary, offering an additional environmental and commercial advantage.

The products of Formula I may be divided into two sub-classes, according to the number of phosphonate groups attached to the aromatic ring. The description now proceeds to discuss each of these two sub-classes separately.

The sub-class of compounds of Formula I in which k equals 1, namely, the dialkyl halogen-substituted aryl monophosphonates, are hereinafter represented by Formula IA:

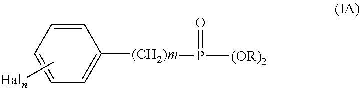

The corresponding starting materials are represented by Formula IIA:

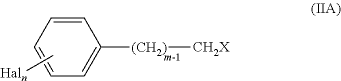

The process for preparing the monophosphonates of Formula IA is illustrated by the following scheme:

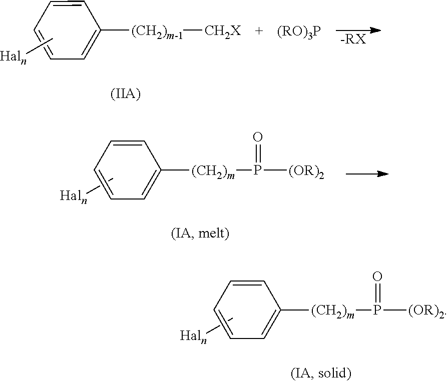

The starting materials used in the process of this invention (the halogenated benzene-(alkyl halide) of formula IIA and trialkyl phosphite) are well known in the art and are commercially available. Regarding the trialkyl phosphite starting material, it is noted that simple phosphites, where all alkyl groups are the same, are preferred over mixed phosphites. Among the starting material of Formula IIA, preferred are halogenated benzyl halides (m equals 1 in formula IIA), and more specifically halogenated benzyl bromide (X is Br in Formula IIA). Such halogenated benzyl bromides are commercially available (for example, FR-706 from ICL-IP). Their preparation is based on the halogenation of toluene in the presence of a Lewis acid catalyst, whereby the substitution on the aromatic ring is achieved. The subsequent halogenation of the methyl group in order to introduce the benzyl halide functionality is carried out in an organic solvent in the presence of chlorine or bromine and a radical initiator under conditions known in the art.

The starting materials are typically reacted in equimolar amounts. However, it is preferred to use the liquid trialkyl phosphite in a slight molar excess relative to the halogenated benzene-(alkyl halide) of formula IIA. Generally, from about 1.0 to 1.1, and preferably 1.0 to 1.05, and more preferably 1.0 to 1.03 moles of trialkyl phosphite per mole of the starting material of formula IIA are suitably used. At the beginning of the reaction, this amount of trialkyl phosphite charged into the reaction vessel is generally sufficient for providing an easily stirred reaction mixture. When the reaction is in progress, the trialkyl phosphite is gradually consumed; however, the resultant product is formed and maintained as a liquid, providing a stirrable liquid reaction mass.

The process of the invention may be run in a batch mode, where the feeds of the reactants to the reactor are continued until the reactor is filled to a desired level, and the feeds are stopped. It should be noted that the starting materials may be fed to the reaction vessel in any order, either concurrently or consecutively. The mixture of the two reactants is heated under stirring to form a solution, and the reaction is completed to give a reaction mass consisting essentially of the liquid product of formula IA, which is subsequently removed from the reaction vessel and is allowed to solidify.

An alternative feeding and operation method involves pre-charging the reaction vessel with a relatively small amount of the product of Formula I in a liquid (molten) state, in order to provide a liquid medium in the reaction zone prior to the commencement of the reaction, thereby facilitating the exothermic reaction. The reactants are then added to the reaction vessel, and the hot reaction slurry mixture comprising the pre-charged molten product and the two reactants is stirred under heating to gradually form a solution, wherein the reaction is completed to afford the liquid product of Formula IA. This variant of the invention may be conveniently run in a semi-batch, semi-continuous like mode of operation, wherein after the completion of the reaction, a certain fraction of the liquid product is left in the reaction vessel in order to serve as the pre-charged liquid product for the next batch.

The preferred feeding and operation methods set forth above shall now be described in more detail. In any case, the reaction mixture is maintained at a sufficiently high temperature such that the product present is in a liquid state throughout the reaction.

One way of carrying out the reaction according to the present invention comprises adding the halogenated benzene-(haloalkyl) of formula (IIA) and the liquid trialkyl phosphite to the reaction vessel, heating the reaction mixture (free of a non-indigenous diluent or solvent) under stirring to form a solution, maintaining the reaction mass in a liquid state, until the reaction is completed and distilling the haloalkane by-product either concurrently or after the reaction, to give a reaction mass which is a substantially pure liquid product, and then solidifying said product. The reaction is preferably carried out under inert atmosphere to prevent side reactions. Such an atmosphere can be provided by inert gases such as nitrogen, argon and the like. The temperature of the reaction mass during at least a substantial portion of the reaction is above the melting point of the product of, formula IA, and preferably below the boiling point of the trialkyl phosphite of the formula (RO)₃P. More specifically, the temperature of the reaction mixture may be in the range between 80 and 180° C., and even more specifically, between 100 and 150° C. It is also noted that at the temperature range indicated above, the distillation of the haloalkane by-product may be sometimes accomplished concurrently with the reaction (this of course depends on the boiling point of said haloalkane by-product). Typical reaction duration is between 30 and 180 minutes. The progress of the reaction may be monitored by the temperature and the evolution of alkyl halide. For example, when the product to be prepared is diethyl pentabromobenzylphosphonate, then the cessation of the evolution of ethyl halide (e.g., C₂H₅Br) serves as an indicator to determine the end of the reaction.

More specifically, the reaction vessel which contains the reactants is initially heated to a temperature in the range between 100 and 150° C., and is kept at a temperature in said range until the reaction is substantially completed. For example, when the desired product is diethyl pentabromobenzylphosphonate, then the reaction mixture is maintained at temperature of about 130-150° C. Under these conditions, the product obtained is a liquid component of the reaction mass. When there is an indication that the reaction is about to reach or has reached completion (the cessation of the alkyl halide evolution, or a sharp drop of the reaction temperature), then further heat is supplied to the reaction vessel, assuring that the reaction mass is kept at a temperature above the melting temperature of the product. Preferably, the reaction vessel is heated to about 140-160° C., and is kept at the selected temperature for an additional period of time, e.g., about 10 to 70 minutes, during which period residual amounts of the alkyl halide by-product and the excess trialkyl phosphite starting material are removed from the reaction mass under reduced pressure, thus leaving a substantially pure molten product in the reaction vessel. It should be noted that when the alkyl halide by-product (for example, butyl halide) has a boiling point above the reaction temperature, then said by-product is not removed from the reaction mixture concurrently with the reaction. In such a case, the entire amount of the alkyl halide by-product is distilled after the reaction.

The reaction described above is capable of affording the desired product with an excellent yield and high degree of purity. However, as mentioned above, in view of its exothermic character, it may be sometimes desirable to carry out the reaction under more controllable conditions. In this regard, it has been found useful to provide in the reaction vessel an amount of the desired product in a molten state, prior to the addition of the reactants. The ratio between the initially charged molten product to the reactant of formula (IIA) may be in the range from 1:1 to 1:10, such that the initially charged molten material preferably occupies about 15-25% of the reactor's volume. According to this variant of the invention, the temperature of the reaction vessel (which is free of a non-indigenous diluent or solvent), is kept above the melting point (T_{melting}) of the product already from the beginning, thus holding the initially charged product in a molten state, while the starting material of formula IIA is being charged to the reaction vessel to form a stirrable slurry with the molten material. Then, the second reactant—the trialkyl phosphite—is gradually fed to the reaction vessel. The addition of the trialkyl phosphite is preferably carried out over a period of time, wherein the rate of the addition is adjusted in order to control the exothermic behavior of the reaction and the evolution of the alkyl halide by-product. More specifically, the gradual addition of the trialkyl phosphite into the reaction vessel may be accomplished either continuously, over a period of time of not less than 30 minutes at an approximately constant rate or in a portion-wise manner, such that approximately equal quantities of the trialkyl phosphite are sequentially charged into the reaction mixture over a period of time, at intervals of about 5 to 10 minutes, for example. The rate of addition generally depends on the reaction scale and the controllability of the temperature, namely, the removal of the heat generated by the reaction. On an industrial scale, the gradual addition of the trialkyl phosphite may require a number of hours and the rate of addition may be adjusted according to the considerations noted above. Preferably, the trialkyl phosphite is fed to the reaction vessel through a dipping funnel, either below or above the level of the liquid contained in the reaction vessel. It has been observed that following the addition of approximately 25% of the contemplated stoichiometric amount of trialkyl phosphite, the reaction mixture slurry turns into a solution. The addition of the trialkyl phosphite starting material then continues at a rate such that the temperature of the reaction mass does not exceed 130-150° C. For example, when the product prepared is diethyl pentabromobenzylphosphonate, the rate of addition of the triethyl phosphite may be adjusted such that the temperature of the reaction mass is within the range between about 135-145° C. Under the feeding method set forth above, the distillation of the alkyl bromide by-product is gently accomplished.

Having completed the gradual addition of the trialkyl phosphite starting material according to this alternative feeding method of the invention, the reaction, carried out under inert atmosphere as described above, is allowed to reach completion (signaled by a temperature drop). The reaction mass is then heated and brought to higher temperature. The reaction mass is kept at the selected temperature (which is about 145-155° C.) for about 10 to 60 minutes. Residual amounts of the alkyl bromide by-product and the excess trialkyl phosphite starting material are then removed from the reaction mass under reduced pressure to afford a substantially pure molten product in the reaction vessel.

Having obtained the liquid product by means of any one of the methods described above, the product may be conveniently collected in a solid form by discharging the liquid material from the reaction vessel and cooling the same, e.g., by contacting the liquid with a cooling surface (e.g., a chilled metallic surface). On an industrial scale, the liquid product may be discharged from the reactor and then applied as a thin layer over the surface of a rotating, internally cooled metal cylinder, (known in the art as drum flaker), whereby the liquid product is solidified to a solid layer and the product is collected in the form of flake particles, which may then be milled to give a powdered material with an average particle size below 100 micron. Of course, any other conventional equipment suitable for solidifying a molten material can be used for this purpose.

An important feature of the present invention is that the in-situ formed product of Formula IA is kept in a liquid state to afford an easily stirred reaction mass in which the reactants are effectively suspended or dissolved, allowing the reaction to reach completion. In the table below, the melting points of some preferred products of Formula (IA) are tabulated:

(IA)

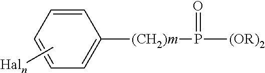

| product | HAL | n | m | R | T_{melting} |
|---|---|---|---|---|---|
| 1 | Br | 3 | 1 | —CH₃ | ~93-95° C.* |
| 2 | Br | 5 | 1 | —CH₃ | ~141-142° C.* |
| 3 | Br | 5 | 1 | —CH₂CH₃ | ~123-124° C. |
| 4 | Br | 5 | 1 | —CH(CH₃)₂ | ~113-115° C.* |
| 5 | Br | 5 | 1 | —(CH₂)₃CH₃ | ~75° C. |

*Liaw et al., supra

It may be seen that the preferred compounds of Formula IA are characterized by relatively low melting points, such that the process of the invention may be run at temperatures which do not exceed 150° C.

The preferred compounds of formula IA to be prepared by the process of the invention are perbrominated (Hal is bromine and n equals 5). An especially preferred product of formula IA to be prepared according to the invention is diethyl pentabromobenzylphosphonate (see entry 3 in the table above; this compound is hereinafter sometimes abbreviated DEPBBP). The starting materials to be used for preparing DEPBBP are pentabromobenzyl bromide (commercially available from ICL-IP (FR-706)) and triethylphosphite (commercially available from Fluka). The preparation of DEPBBP is illustrated by the following scheme (a reduced form of the general scheme):

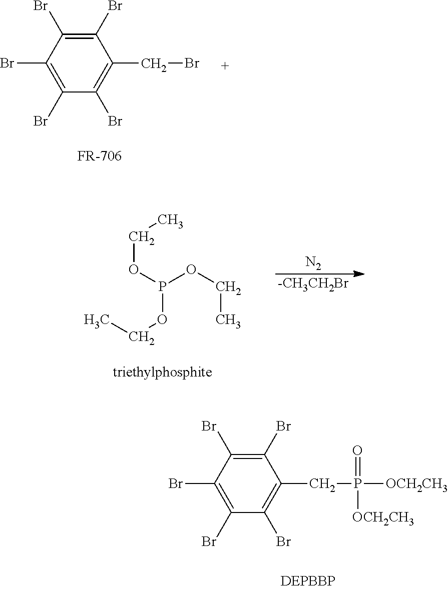

Diethyl pentabromobenzylphosphonate obtained by the process of the present invention is of high purity, with a melting point in the range between 123.5-124.5° C., as determined by Differential scanning calorimetry (the DSC thermogram was obtained using Mettler-Toledo instrument model 821E; the temperature range scanned was 25° C.-180° C. and the rate of scanning was 10° C./min under nitrogen). The product obtained upon solidifying the molten substance is crystalline, as indicated by its X-ray powder diffraction pattern.

Another preferred product of formula IA to be prepared according to the invention is dibutyl pentabromobenzylphosphonate, represented by the following formula:

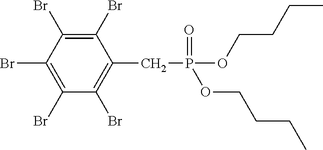

The dialkyl halogen-substituted aryl phosphonates of formula I to be prepared according to the present invention are useful as flame retardants and may be formulated with various flammable polymers, as described in GB 2228939. Illustrative polymers include, inter alia, polystyrene, high impact polystyrene and acrylonitrile-butadiene-styrene (ABS). The dialkyl halogen-substituted aryl phosphonates of formula I and other ingredients of the polymeric formulation are blended together according to their respective amounts. In general, the polymeric formulation may contain from about 0.5 to 30%, preferably from 1 to 15% by weight of the flame retardant of formula I. The formulation may further include conventional additives such as inorganic synergists (Sb₂O₃), impact modifiers, pigments, UV stabilizers, heat stabilizers, fillers, lubricants and antioxidants. The resulting mixture may then be processed and compounded to form homogeneous pellets, for example, by using a twin screw extruder. The pellets obtained are dried, and are suitable for feed to an article shaping process such as injection molding. Other blending and shaping techniques can also be applied.

The sub-class of compounds of Formula I in which k equals 2, namely, the dialkyl halogen-substituted aryl diphosphonates, are hereinafter represented by Formula IB:

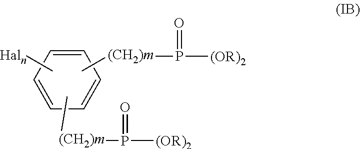

Wherein n is an integer between 1 and 4, inclusive, and the other variables (Hal, m and R) have the meanings indicated before. The corresponding starting materials which are used for preparing the compounds of formula IB are represented by formula IIB:

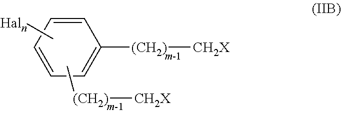

The starting materials of formula (IIB) are reacted with the trialkyl phosphite of the formula (RO)₃P according to the conditions outlined above, in a reaction vessel which is essentially undiluted, namely, free of a non-indigenous organic diluent or solvent. A slight molar excess of the phosphite is preferably used. The reaction affords the product of Formula IB in a liquid form. Most products of formula IIB are solids at room temperature. Accordingly, the molten product obtained from the synthesis may be allowed to solidify by the methods set forth above, whereby a solid material can be recovered.

Especially preferred starting materials of formula IIB are those wherein m equals 1, i.e., xylene derivatives in which the aromatic ring is substituted with three or four halogen atoms (n equals 3 or 4), and the two methyl groups are substituted with chlorine or bromine. (X=Br or Cl). It is noted that the compounds represented by Formula IIB include all possible halogenated xylene derivatives, i.e., o-, m- and p-xylenes. The most preferred starting materials of Formula IIB are the tetrabrominated xylenes, in which each of the methyl groups is further substituted with bromine atom, that is, tetrabrominated xylene dibromide. More specifically, the starting material is selected from the group consisting of para tetrabromoxylene dibromide (α,α′-2,3,5,6-hexabromo-p-xylene), meta tetrabromoxylene dibromide (α,α′-2,4,5,6-hexabromo-m-xylene), ortho tetrabromoxylene dibromide (α,α′-3,4,5,6-hexabromo-o-xylene), and mixtures thereof. The starting materials set forth above may be provided either as the individual para, ortho and meta isomers or as mixtures thereof. The preparation of the starting materials is described in U.S. Pat. No. 4,107,104. Briefly, p-xylene, o-xylene, m-xylene or a mixture thereof is brominated in the presence of a Lewis acid, such as aluminum bromide, using a large excess of bromine (which functions both as a solvent and reagent). This allows the bromination on the aromatic ring, affording tetrabrominated p-xylene, o-xylene, m-xylene or a mixture thereof. The tetrabrominated xylene intermediate is isolated, and the bromination of the methyl groups of said intermediate is subsequently accomplished in an organic solvent by reaction with bromine under conditions known in the art, yielding the most preferred starting materials represented by Formula IIB.

Accordingly, the preferred products of Formula IB, obtainable upon reacting the starting materials identified above with trialkyl phosphite of the formula (RO)₃P, have the following formula:

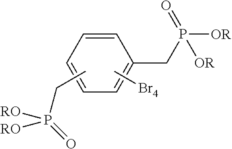

wherein R is as previously defined. The class of α,α′-bis-(dialkoxyphosphinyl) tetrabromo xylene depicted above includes the corresponding ortho, meta and para compounds and mixtures thereof, wherein R is preferably ethyl or butyl (more specifically, n-butyl) as shown below:

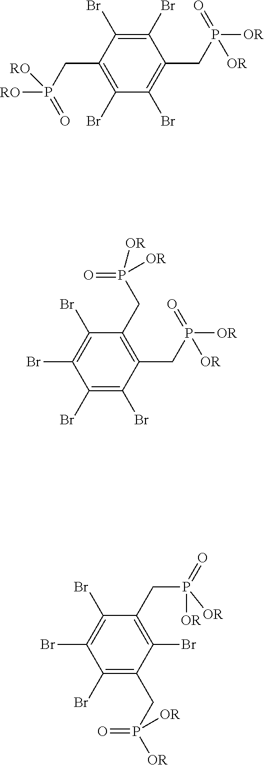

From among the compounds illustrated above, the butyl ester derivatives are of particular interest. The ortho, meta and para isomers of the butyl derivatives are depicted below:

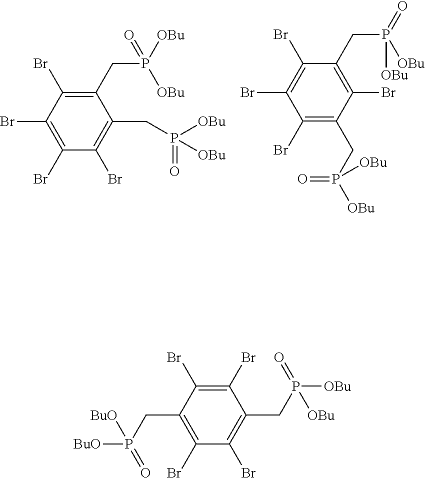

(wherein Bu is preferably n-butyl). The mixture of α,α′-bis-(dibutoxyphosphinyl) tetrabromo p-xylene and α,α′-bis-(dibutoxyphosphinyl) tetrabromo m-xylene {also chemically named [(2,3,5,6-tetrabromo-1,4-phenylene)bis(methylene)]bis-tetrabutyl ester phosphonic acid and [(2,4,5,6-tetrabromo-1,3-phenylene)bis(methylene)]bis-tetrabutyl ester phosphonic acid} is liquid at room temperature under atmospheric pressure. In view of its high bromine and phosphorous content, the mixture may be useful as a flame retardant in applications where liquid flame retardant is preferred over a solid one, such as in textile applications. Each of the o, m, p isomers of the butyl derivatives depicted above, and any possible mixture thereof, and specifically the meta/para mixture, form a further aspect of the present invention.

### EXAMPLES

### Example 1

### Preparation of diethyl pentabromobenzylphosphonate

Into a 500 ml round bottomed flask equipped with mechanical stirrer, nitrogen inlet, and a pipe to a cooled (under ice) trap, were placed pentabromobenzyl bromide (PBB-Br (FR-706 from ICL-IP), 330 gr., 0.58 mol) and triethylphosphite (110 ml, (105 gr.) 0.63 mol).

The mixture was gradually heated. The temperature was raised from 25° C. up to 100° C. over 50 min. During this period of time, PBB-Br completely dissolved in the hot triethylphosphite and the solution became yellowish. Ethylbromide started to evolve at 95° C. The temperature of the heating oil was kept at 100° C. An exothermic behavior is observed. The temperature rose spontaneously in the reaction vessel to 105° C. The temperature then increased to 110° C. and the reflux became stronger till 136° C. The temperature then dropped to 117° C. At this point the temperature of the heating plate was raised to 150° C. The temperature was maintained at 150° C. for one hour. At 150° C. a vacuum pump was applied in order to distill the residue of ethylbromide and the slight excess of triethylphosphite. The distillate (52 gr. of ethylbromide) was trapped in the cold trap. The reaction mixture was spread as a molten product on aluminum foil. The molten product cooled to room temperature and flakes were obtained. The flaked product had an off-white color, 360 gr, 0.578 mole, 99% yield. The flakes were milled and a white powder was obtained.

### Example 2

### Preparation of diethyl pentabromobenzylphosphonate Semi-continuous process

Into a 250 ml round bottomed flask equipped with mechanical stirrer, nitrogen inlet, a pipe to a cooled (under ice) trap and a dripping funnel 50 ml, was added diethyl pentabromobenzylphosphonate (30 g) and the vessel was heated to 130° C., whereby diethyl pentabromobenzylphosphonate melts. Pentabromobenzyl bromide (PBB-Br (FR-706 from ICL-IP), 80 g, 0.14 mol) was added to the molten diethyl pentabromobenzylphosphonate, to form a stirrable slurry (the mixing was good). Triethylphosphite (Fluka, 26.6 ml, 0.15 mol) was placed in the dripping funnel.

The temperature of the heating plate is kept at 130° C. during the reaction time. Triethylphosphite was added adjacent to the surface of the slurry at 130° C. through the dripping funnel. A mild bubbling of ethylbromide was observed which was retained in the cold trap. The temperature increased from 136° C. up to 142° C. spontaneously. The exothermic behavior is controlled by the dripping rate of triethylphosphite. The PBB-Br is fully dissolved in the molten product and a solution is formed after the addition of about 25% of the triethylphosphite. The reaction mixture was held at 136° C. to 142° C. during the addition period of the first half portion of triethylphosphite, by means of controlling the dripping rate of triethylphosphite.

During the addition of the remaining quantity of triethylphosphite, the reaction temperature decreased to 133° C. and the temperature was essentially constant until the end of triethylphosphite addition. At the end of the addition period, the reaction mass is heated to 150° C. and is held at 150° C. for one hour.

The temperature was lowered to 130° C. and a vacuum pump was applied in order to distill the residue of ethylbromide and the slight excess of triethylphosphite. The reaction mixture was then spread as a molten product on aluminum foil. The molten product was cooled to room temperature and flakes were obtained. The flaked product had an off-white color, a weight of 117 g (including the initially charged quantity of 30 g) equivalent to 0.14 mole. This represents essentially 100% yield. The flakes were milled and a white powder was obtained (melting point 123.8° C.). A sample was recrystallized from ethyl acetate (melting point 124.5° C., elemental analysis for C₁₁H₁₂Br₅O₃P, calculated: % Br, 64.16; % P, 4.97. Found: % Br, 64.10; % P, 4.85).

H′NMR: (500 MHz, CDCl₃) δ (ppm): 1.29 (6H, t, H₁), 3.95 (2H, d, H₂), 4.10 (4H, m, H₃).

### Example 3

### Preparation of dibutyl pentabromobenzylphosphonate

In a 500 ml round bottomed flask equipped with mechanical stirrer, nitrogen inlet, and a pipe to a cooled (under ice) trap, were placed pentabromobenzyl bromide (PBB-Br (FR-706 from ICL-IP), 165 gr., 0.29 mol) and tributylphosphite (86.6 ml, (79.2 gr.) 0.31 mol).

The mixture, which is a slurry of PBB-Br in tributylphosphite, was gradually heated. The temperature was raised from 25° C. up to 123° C. over 60 min. and an exothermic behavior is observed with strong reflux at this point. The temperature rose spontaneously in the reaction vessel to 156° C. PBB-Br was completely dissolved at 140° C. in tributylphosphite and the solution became brownish. The temperature of the heating oil was kept at 130-135° C. The temperature then dropped to 130° C. At this point the temperature of the heating plate was raised to 150° C. The temperature was maintained at 150° C. for one hour. After one hour at 150° C. a vacuum pump was applied in order to distill the butylbromide and the slight excess of tributylphosphite. The distillate (20 ml. of butylbromide) was collected in the cold trap. The reaction mixture was spread as a liquid product on aluminum foil. The liquid product cooled to room temperature and flakes were obtained. The flaked butyl derivative had an off-white color, 195 gr, 0.29 mole, about 100% yield. The flakes were milled and a white powder was obtained. The melting point: 75° C.

### Example 4

### Preparation of a mixture of α,α′-bis-(dibutoxyphosphinyl)tetrabromo m-xylene and α,α′-bis-(dibutoxyphosphinyl)tetrabromo p-xylene

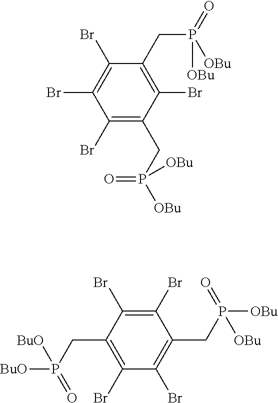

Into a 250 ml round bottomed flask equipped with mechanical stirrer, nitrogen inlet, dropping funnel and an outlet pipe into a cooled trap (under ice), was placed a mixture of meta and para tetrabromoxylene dibromide (80 gr., 0.138 mol; abbreviated hereinafter TBXDB) and tributylphosphite (70 gr., 0.279 mol 1% molar excess). The amount of tributylphosphite was divided into two portions. The first portion, (35 g, 0.139 mole) was added into the reaction vessel together with TBXDB. The mixture which is a slurry of TBXDB in tributylphosphite, was gradually heated. The temperature was raised from 25° C. up to 105° C. over 60 min with an oil bath. An exothermic behavior is observed with strong reflux at this point. The temperature rose spontaneously in the reaction vessel to 134° C. TBXDB was completely dissolved at this temperature in tributylphosphite and the solution became brownish. When the temperature spontaneously decreased to 105° C., after 10-15 minutes, the second portion of tributylphosphite was added drop wise into the reaction vessel over a period of 20-30 minutes. During the second addition stage the temperature rose spontaneously in the reaction vessel to 116° C. with gentle reflux. When the addition of the second portion of tributylphosphite was completed, the oil bath was heated to 150° C. The temperature was maintained at 150° C. for one hour. The outlet pipe was replaced by a Dean-Stark trap and at 150° C., butylbromide and the slight excess of tributylphosphite were removed by vacuum distillation. The reaction mixture was spread on an aluminum foil. Although the product was cooled to room temperature, no solidification occurred and the product remained a liquid. The liquid was brownish colored, (94 gr, 0.117 mole, 85% yield).

Elemental analysis calculated for C₂₄H₄₀Br₄O₆P₂: % Br, 39.7; % P, 7.7. Found: % Br, 38.8; % P 7.6.

### Example 5

### Preparation of α,α′-bis-(diethoxyphosphinyl)tetrabromo o-xylene

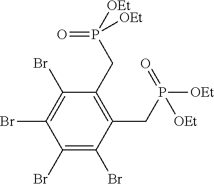

Ortho-tetrabromoxylene dibromide (10.g, 0.01725 mole) and triethylphosphite (5.8.g, 0.035 mole) were reacted according to the procedure described in Example 4. Having completed the reaction, the reaction mass was spread on an aluminum foil. The entitled product, which was allowed to cool to room temperature, solidified. The flakes collected (10.7 gr) had off-white color. The flakes were milled and a white powder was obtained. The melting point was determined by DSC (melt onset 127.9° C., peak temperature 133.5° C.). Elemental analysis calculated for C₁₆H₂₄Br₄O₆P₂: % Br, 46.1; % P, 8.9. Found: % Br, 47.9; % P, 8.3.

### Example 6

### Preparation of a mixture of α,α′-bis-(diethoxyphosphinyl)tetrabromo m-xylene and α,α′-bis-(diethoxyphosphinyl)tetrabromo p-xylene

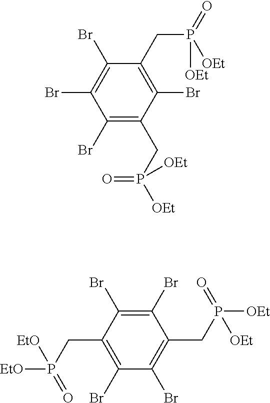

A mixture of para and meta tetrabromoxylene dibromide (80.g, 0.138 mole) and triethylphosphite (46.5.g, 0.280 mole) were reacted according to the procedure described in Example 4. Having completed the reaction, the reaction mass was spread on an aluminum foil. The entitled product mixture, which was cooled to room temperature, solidified. The flakes collected (96.5 gr) had off-white color. The flakes were milled and a white powder was obtained. The melting point was determined by DSC (melt onset 92.1° C., peak temperature 104.4° C.). Elemental analysis calculated for C₁₆H₂₄Br₄O₆P₂: % Br, 46.1; % P, 8.9. Found: % Br, 44.3; % P, 8.7.

1-15. (canceled)

16. A process for preparing halogen-substituted aryl phosphonates represented by formula (I): 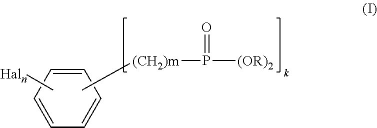
wherein each Hal independently represents halogen; k is 1 or 2; n is an integer between 1 and 3, inclusive; and R is a straight or branched C1-C5 alkyl group which may be optionally substituted with one or more halogen atoms, which process comprises reacting under heating a compound represented by the following formula: 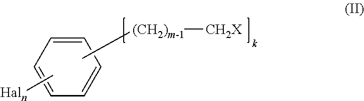
wherein X is a leaving group, with trialkyl phosphite of the formula {RO)₃P, wherein the product of Formula I is produced and maintained in a liquid form and functions as an indigenous reaction liquid medium for suspending or dissolving the reactants, wherein the temperature of the reaction mixture is not less than the melting temperature of said compound of Formula I during at least a portion of the reaction time, and recovering the product of Formula I in a liquid form.

17. A process according to claim 16, wherein m equals 1 and the leaving group X is halide selected from the group consisting of chloride and bromide.

18. A process according to claim 17, which process comprises bringing the reaction to completion at a temperature which is not less than the melting temperature of said compound of Formula I, wherein the reaction is free of a non-indigenous diluent or solvent, removing alkyl halide (RX) by-product from the reaction mixture either concurrently with or subsequent to the reaction, obtaining a reaction mass comprising said compound of Formula I in a liquid state, wherein the compound of Formula I is recovered in a substantially pure liquid form, and optionally solidifying said liquid of Formula I and collecting the product in a solid form.

19. A process according to claim 16, wherein from 1.0 to 1.1 moles of trialkyl phosphite per mole of the starting material of formula II are used.

20. A process according to claim 16, which process comprises pre-charging the reaction vessel with the product of Formula I in a molten form prior to the commencement of the reaction, adding the starting materials of Formula II and the trialkyl phosphite of the formula (RO)₃P to the reaction vessel, stirring the reaction mixture under heating to gradually form a solution while producing and maintaining the compound of Formula I in a liquid form.

21. A process according to claim 20, wherein the trialkyl phosphite is gradually fed to the reaction vessel, with the rate of the addition being adjusted in order to control the exothermic behavior of the reaction.

22. A process according to claim 16, for preparing a compound represented by formula IA: 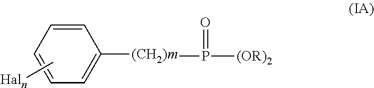
(IA) wherein Hal is bromine, n equals 5, m equals 1 and R is as defined in claim 1, which process comprises reacting a starting material of Formula IIA: 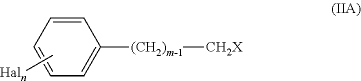
with trialkyl phosphite of the formula (RO)aP, wherein Hal, n, m and R are as defined above and X is Br or CI.

23. A process according to claim 22, which comprises recovering the product of Formula I in a liquid form and subsequently cooling and solidifying the product.

24. A process according to claim 23, wherein the solid product obtained is crystalline.

25. A process according to claim 22, wherein the product of formula IA is selected from the group consisting of diethyl pentabromobenzylphosphonate: 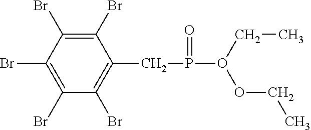
and dibutyl pentabromobenzylphosphonate

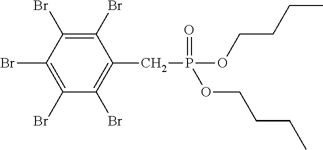

26. A process according to claim 16, for preparing a compound represented by formula IB: 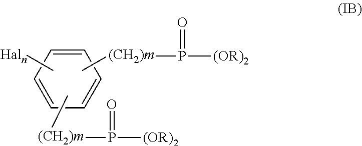
wherein Hal is bromine, n equals 4, m equals 1 and R is as defined in claim 1, which process comprises reacting a starting material of Formula IIB: 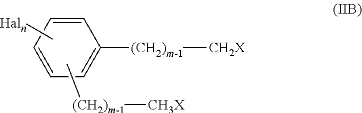
with trialkyl phosphite of the formula (RO3P, wherein Hal, n, m and R are as defined above and X is bromine or chlorine.

27. A process according to claim 26, wherein the product of formula IB prepared by said process is selected from the group consisting of the following halogen-substituted aryl diphosphonates and their mixtures: 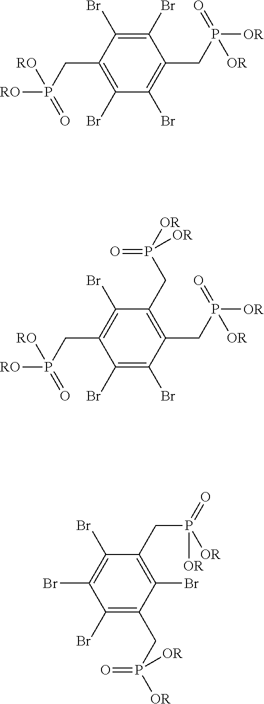
wherein R is ethyl or butyl.

28. A process according to claim 27, wherein the product of formula IB is a liquid mixture comprising [(2,3,5,6-tetrabromo-1,4-phenylene)bis(methylene)]bis-tetrabutyl ester phosphonic acid and [(2,4,5,6-tetrabromo-1,3-phenylene)bis(methylene)]bis-tetrabutyl ester phosphonic acid having the formulas:

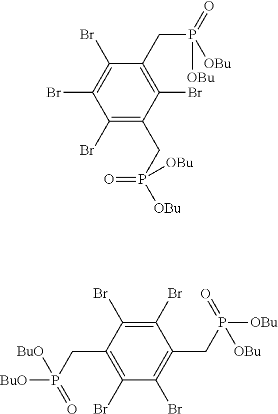

29. A compound selected from the group consisting of the following bromine-containing diphosphonates and their mixtures: 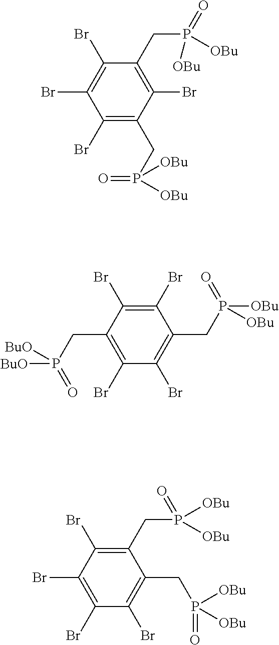
Wherein Bu indicates a butyl group.

30. A compound according to claim 29, which is a mixture of the meta and para derivatives: [chemical structure]
